(19) United States
(12) Patent Application Publication
(10) Pub. No.: US 2012/0210827 A1
(43) Pub. Date: Aug. 23, 2012

(54) ROD TONG ASSEMBLY

(76) Inventor: Don Darrell Hickman, Williston, ND (US)

(21) Appl. No.: 13/276,171

(22) Filed: Oct. 18, 2011

Related U.S. Application Data
(60) Provisional application No. 61/394,305, filed on Oct. 18, 2010.

(51) Int. Cl. E21B 19/16; B25B 23/151; B25B 23/145

(52) U.S. Cl. 81/57.11; 173/182; 173/1

(57) ABSTRACT

A tong assembly includes a case assembly and a tong head assembly disposed in the interior of the case assembly and adapted to engage a first sucker rod. A transmission assembly engaged to a hydraulic motor and including a backup tong assembly. The backup tong assembly includes a backup tong having a first end and an oppositely disposed second end adapted to hold a second sucker rod. A load pin engaged to the second end of the backup tong and an outer casing of the transmission assembly, the load pin includes strain gages for measuring a force applied to the first end of the backup tong to output a force signal. A rotary encoder engages a shaft of the hydraulic motor and outputs a position signal when a. A controller generates an output signal based on only one of the force signal or the position signal when the force signal is greater than a predetermined value or when the position signal is within a predetermined range of values. The output signal actuates a valve to direct fluid from the hydraulic motor to a hydraulic fluid reservoir.

### BACKGROUND

Power tongs are frequently used in the oil and gas industry for threadably connecting and disconnecting oil field tubulars such as those commonly referred to as casing, tubing and as “sucker” rods. Power tongs include a tong assembly and a transmission assembly. The transmission assembly typically includes a hydraulic motor and an operator valve. The tong assembly typically includes either a closed-head tong or an open-head tong having a jaw which engages the tubulars. When the jaw of the tong assembly is clamped onto the tubulars, the transmission assembly causes the tong assembly to rotate in either a clockwise or counterclockwise direction to either thread or unthread the tubular.

### SUMMARY OF THE INVENTION

An aspect of the present disclosure relates to a tong assembly system. The tong assembly system includes a tong assembly including a case assembly defining an interior. A tong head assembly is disposed in the interior. The tong head assembly includes an outer ring gear and a tong head engaged to the outer ring gear. The tong head is adapted to receive a first sucker rod. A transmission assembly is engaged to the case assembly. The transmission assembly is engaged to a hydraulic motor and includes a backup tong assembly. The backup tong assembly includes a backup tong having a first end and an oppositely disposed second end. The first end is adapted to hold a second sucker rod. A load pin is engaged to the second end of the backup tong and an outer casing of the transmission assembly. The load pin includes a plurality of strain gages for measuring a force applied to the first end of the backup tong. The load pin is adapted to output a force signal. A rotary encoder is engaged to a shaft of the hydraulic motor. The rotary encoder is adapted to output a position signal.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

Referring now to the drawings, wherein like reference letters and numerals indicate corresponding structure throughout the several views:

FIG. 1 is a side view of a tong assembly having exemplary features of aspects in accordance with the principles of the present disclosure;

FIG. 2 is a side view of an exemplary sucker rod assembly that is suitable for use with the tong assembly shown in FIG. 1;

FIG. 3 is a side view of a transmission assembly and a case assembly suitable for use with the tong assembly shown in FIG. 1;

FIG. 4 is a top view of an exemplary gear assembly suitable for use with the tong assembly shown in FIG. 1;

FIG. 5 is a view of a backup tong assembly suitable for use with the tong assembly shown in FIG. 1; and

FIG. 6 is a schematic representation of a tong assembly system having exemplary features of aspects in accordance with the principles of the present disclosure.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

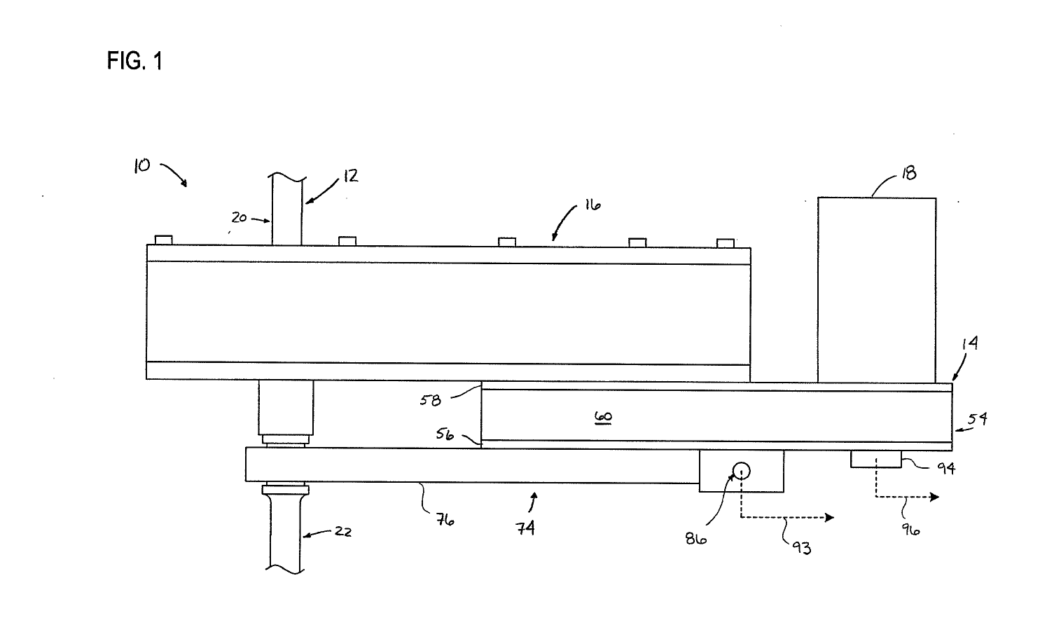

Referring now to FIG. 1, a tong assembly 10 is shown. In the depicted embodiment, the tong assembly 10 is an open-head tong assembly. The tong assembly 10 of the present disclosure is adapted for use with threaded tubulars, such as those commonly referred to as casing, tubing or “sucker” rods. In the present disclosure, the tong assembly 10 is adapted for use with a sucker rod assembly 12.

The tong assembly 10 includes a transmission assembly 14 and a case assembly 16. In one aspect of the present disclosure, a hydraulic motor 18 is engaged to the transmission assembly 14.

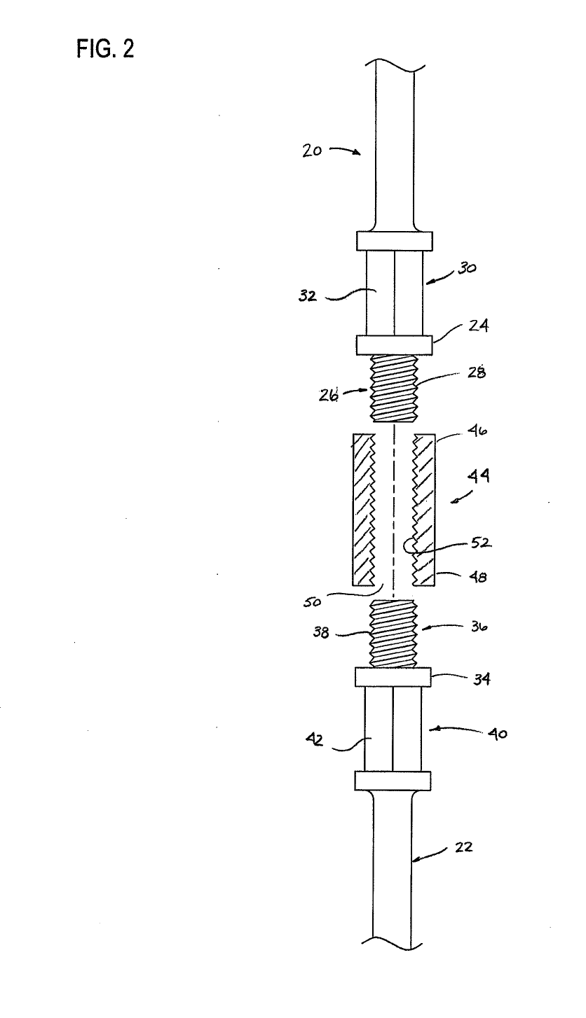

Referring now to FIG. 2, a sucker rod assembly 12 is shown. The sucker rod assembly 12 includes a first sucker rod 20 and a second sucker rod 22. The first sucker rod 20 includes a first shoulder 24 and a first end 26. The first end 26 extends outwardly from a first side of the first shoulder 24 and includes a plurality of external threads 28. In the depicted embodiment, the first shoulder 24 has an outer diameter that is greater than the outer diameter of the plurality of threads 28 of the first end 26. The first sucker rod 20 further includes a gripping portion 30 that extends outwardly from a second side, which is opposite the first side, of the first shoulder 24. In the depicted embodiment, the gripping portion 30 of the first sucker rod 20 includes a plurality of flats 32. In one embodiment, the gripping portion includes four flats 32 so that the gripping portion 30 is generally rectangular (e.g., square) in cross-section.

The second sucker rod 22 includes a second shoulder 34 and a second end 36. The second end 36 extends outwardly from a first side of the second shoulder 34 and includes a plurality of external threads 38. In the depicted embodiment, the second shoulder 34 has an outer diameter that is greater than the outer diameter of the plurality of threads 38 of the second end 36. The second sucker rod 22 further includes a gripping portion 40 that extends outwardly from a second side, which is opposite the first side, of the second shoulder 34. In the depicted embodiment, the gripping portion 30 of the second sucker rod 22 includes a plurality of flats 42. In one embodiment, the gripping portion includes four flats 42 so that the gripping portion 40 is generally rectangular (e.g., square) in cross-section.

The sucker rod assembly 12 includes a coupler 44. The coupler 44 includes a first axial end 46 and an oppositely disposed second axial end 48. The coupler 44 defines a bore 50 that extends through the first and second axial ends 46, 48. In the depicted embodiment, the coupler 44 includes a plurality of internal threads 52 disposed in the bore 50. The internal threads 52 are adapted to receive the external threads 28, 38 of the first and second ends 26, 36 of the first and second sucker rods 20, 22.

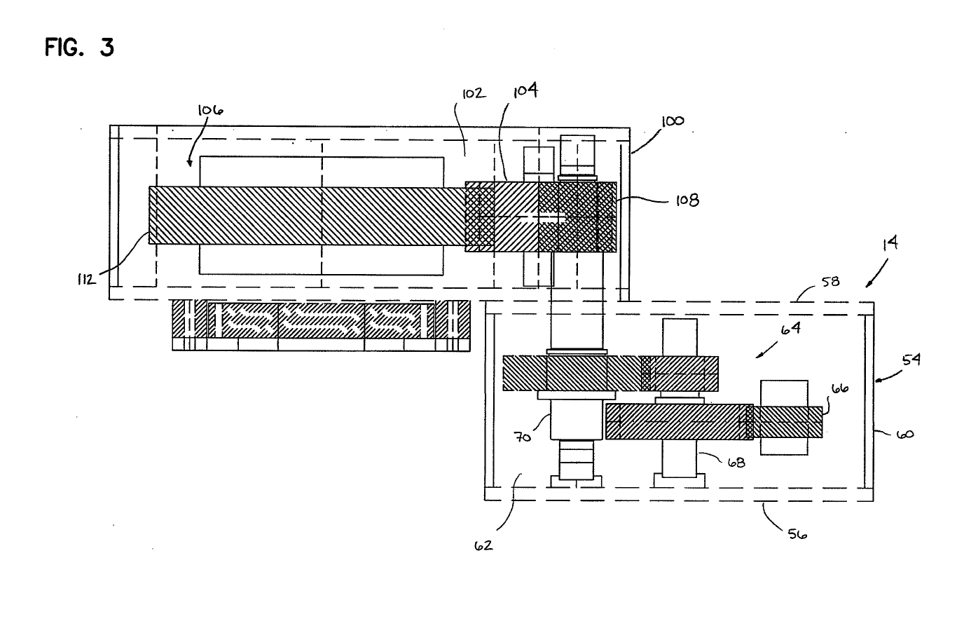

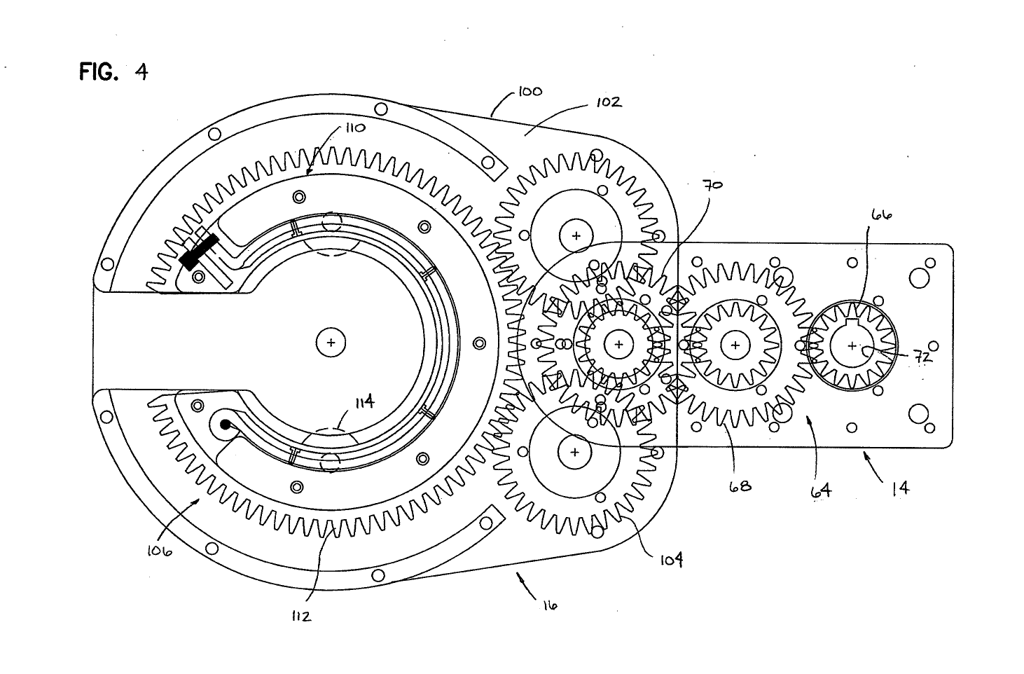

Referring now to FIGS. 1 and 3-5, the transmission assembly 14 includes an outer casing 54. The outer casing 54 includes a base plate 56, a cover plate 58 and a sidewall 60 disposed between the base plate 56 and the cover plate 58. In one embodiment, the sidewall 60 is fastened to the base plate 56 and the cover plate 58. The base plate 56, the cover plate 58 and the sidewall 60 can all be manufactured from steel plate.

The base plate 56, the cover plate 58 and the sidewall 60 cooperatively define an interior region 62 of the outer casing 54. A gear assembly 64 is disposed in the interior region 62 of the outer casing 54. In one aspect of the present disclosure, the gear assembly 64 includes a motor pinion gear 66, a first gear set 68 and a second gear set 70. The motor pinion gear 66 is engaged to the first gear set 68, which is engaged to the second gear set 70.

The motor pinion gear 66 defines a bore 72 that extends through the motor pinion gear 66. The bore 72 of the motor pinion gear 66 is adapted for engagement with a shaft of the hydraulic motor 18. In one embodiment, the bore 72 is adapted for keyed engagement with the shaft.

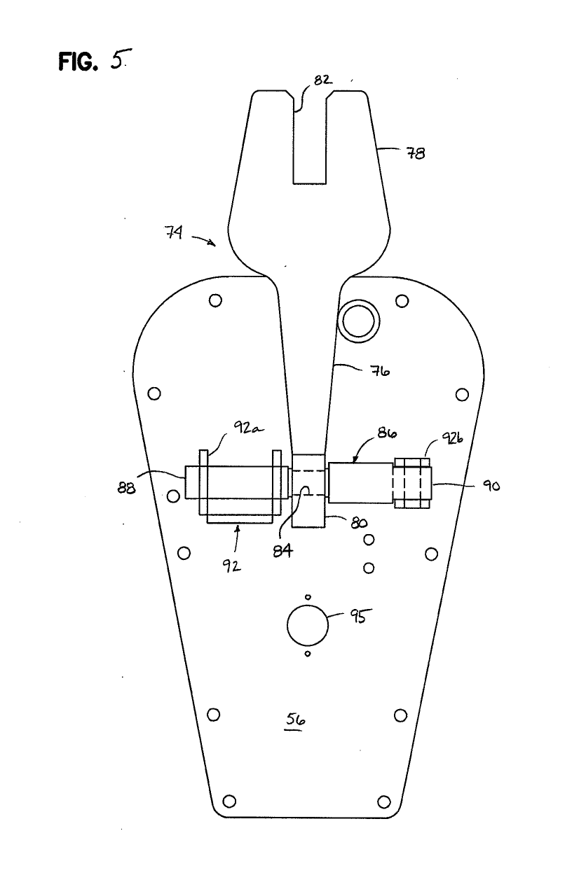

The base plate 56 of the transmission assembly 14 includes a backup tong assembly 74 (shown in FIG. 5). The backup tong assembly 74 includes a backup tong 76 that is adapted to hold the second sucker rod 22 stationary relative to the first sucker rod 20. The backup tong 76 has a first end 78 and an oppositely disposed second end 80. In the depicted embodiment, the first end 78 defines a slot 82 that is adapted to receive the gripping portion 40 of the second sucker rod 22.

The second end 80 defines a thru-hole 84 that extends through the second end 80. The thru-hole 84 is adapted to receive a pin 86. The pin 86 includes a first axial end 88 and an oppositely disposed second axial end 90. The pin 86 is inserted through the thru-hole 84 of the backup tong 76 so that the second end 80 of the backup tong 76 is disposed between the first and second axial ends 88, 90.

The pin 86 is mounted to the base plate 56 by a plurality of mounting brackets 92. In the depicted embodiment, the mounting brackets 92 are fastened (e.g., bolted, welded, etc.) to the base plate 56. The first axial end 88 of the pin 86 is secured to the base plate 56 by a first mounting bracket 92a while the second axial end 90 is secured to the base plate 56 by a second mounting bracket 92b.

In the depicted embodiment, the pin 86 is a force sensing pin (e.g., a load pin). A pin suitable for use with the backup tong assembly 74 is sold by Strainsert and has model number CBA-0.5-1(SS)X. The pin 86 includes a plurality of strain gages for measuring force applied to the backup tong 76 and outputs a force signal 93 corresponding to the measured force or torque applied to the first end 78 of the backup tong 76.

The backup tong assembly 74 further includes a rotary encoder 94. The rotary encoder 94 is mounted to the base plate 56. In one embodiment, the rotary encoder 94 is engaged to the base plate 56 by a plurality of fasteners (e.g., bolts, etc.). The rotary encoder 94 is adapted to engage the shaft of the hydraulic motor 18. In the depicted embodiment, shaft of the hydraulic motor 18 or a couple engaged to the shaft extends through an opening 95 in the base plate 56.

The rotary encoder 94 is adapted to provide a position signal 96 corresponding to the angular position of the shaft of the hydraulic motor 18. In one embodiment, the rotary encoder 94 is capable of providing 600 pulses per minute. A rotary encoder suitable for use with the backup tong assembly 74 is sold by Dynapar and has model code number HSD35.

Referring now to FIGS. 1, 3 and 4, the case assembly 16 of the tong assembly 10 is adapted to receive the first sucker rod 20 and to rotate the first sucker rod 20 in response to rotation of the hydraulic motor 18. A case assembly suitable for use with the tong assembly 10 has been described in U.S. patent application Ser. No. 12/772,815, which is hereby incorporated by reference in its entirety.

The case assembly 16 includes an enclosure 100 that defines an interior 102. In the depicted embodiment, the case assembly 16 includes a plurality of idler gears 104 and a tong head assembly 106 disposed in the interior 102 of the enclosure 100. The plurality of idler gears 104 is engaged with a pinion gear 108, which is coupled to the second gear set 70 of the transmission assembly 14.

An exemplary tong head assembly 106 suitable for use with the tong assembly 10 is manufactured by BJ Services Company. The tong head assembly 106 includes a tong head 110 in connected engagement with an outer ring gear 112, which is engaged with the idler gears 104. In the depicted embodiment, the tong head 110 includes a bushing 114 and a jaw that is adapted to engage the first sucker rod 20.

Referring now to FIGS. 1, 3 and 4, as the hydraulic motor 18 rotates, the motor pinion gear 66 rotates, which causes the first and second gear sets 68, 70 of the transmission assembly 14 to rotate. The rotation of the second gear set 70 causes the rotation of the pinion gear 108 of the case assembly 16. As the pinion gear 108 rotates, the outer ring gear 112 rotates through the rotation of the idler gears 104. The rotation of the outer ring gear 112 causes the tong head 110 to rotate. As the tong head 110 is engaged to the first sucker rod 20, the rotation of the tong head 110 causes the rotation of the first sucker rod 20. As the second sucker rod 22 is held by the backup tong 76, the rotation of the first sucker rod 20 tightens the first and second sucker rods 20, 22 into the coupler 44. If the rotation of the hydraulic motor 18 is reversed, the rotation of the first sucker rod 20 by the tong head 110 loosens the first and second sucker rods 20, 22 from the coupler 44.

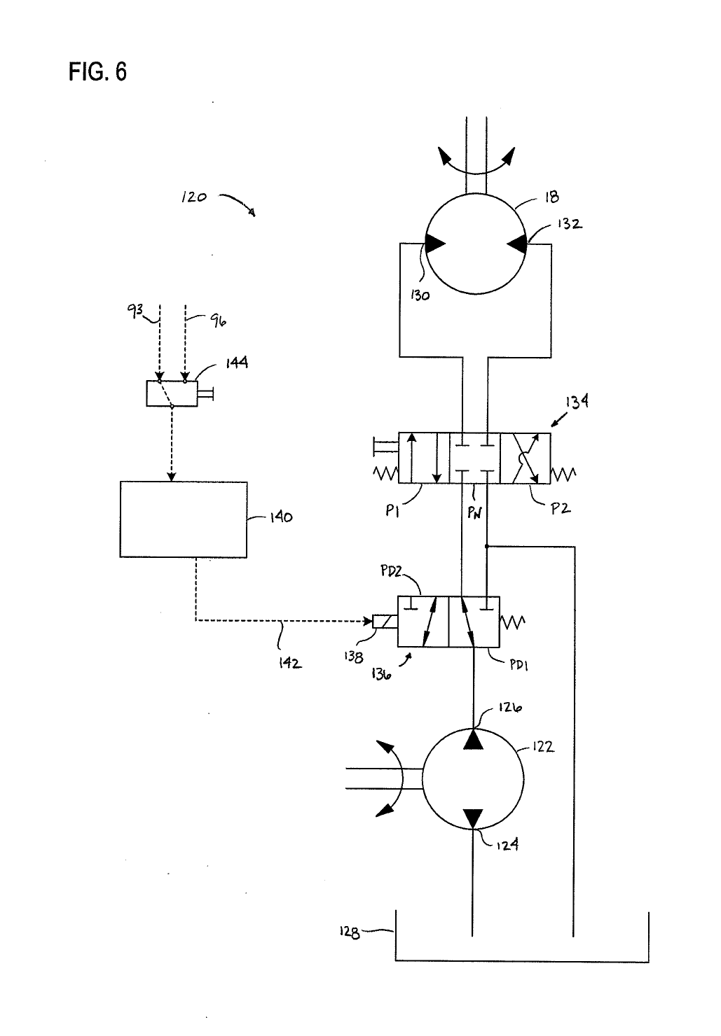

Referring now to FIG. 6, a schematic diagram of a tong assembly system 120 is shown. The tong assembly system 120 includes a pump 122 having a fluid inlet 124 and a fluid outlet 126. The fluid inlet 124 is in fluid communication with a fluid reservoir 128. The fluid outlet 126 is in fluid communication with the hydraulic motor 18. The hydraulic motor 18 includes a first port 130 and a second port 132. It will be understood that while the tong assembly system 120 is being described as an open system (i.e., having an open fluid reservoir); the tong assembly system 120 could be configured as a closed system.

In the depicted embodiment, the fluid outlet 126 is in fluid communication with a directional control valve 134. The directional control valve 134 includes a first position P1, a second position P2 and a neutral position PN. The first position P1 provides fluid communication between the fluid outlet 126 of the fluid pump 122 to the first port 130 and provides fluid communication between the second port 132 and the fluid source 128. The second position P2 provides fluid communication between the fluid outlet 126 of the fluid pump 122 and the second port 132 of the hydraulic motor and provides fluid communication between the first port 130 of the hydraulic motor 18 and the fluid source 128. In the depicted embodiment, the neutral position PN is a closed center position that substantially blocks fluid communication between the fluid pump 122 and the hydraulic motor 18.

The tong assembly system 120 includes a dump valve 136. In the depicted embodiment, the dump valve 136 is disposed between the fluid pump 122 and the directional control valve 134. The dump valve 136 includes a solenoid 138 that is adapted to actuate the dump valve 136 between a first position PD1 and a second position. In the first position PD1, the dump valve 136 provides fluid communication between the fluid pump 122 and the directional control valve 134 so that substantially all of the fluid is communicated to the directional control valve 134. In the second position PD2, the dump valve 136 provides fluid communication between the fluid pump 122 and the fluid source 128 so that substantially all of the fluid is communicated to the fluid source 128.

The tong assembly system 120 further includes a controller 140. The controller 140 is adapted to transmit an output 142 to the solenoid 138 of the dump valve 136 to actuate the dump valve 136 between the first and second positions PD1, PD2.

The output signal 142 is based on only one of the force signal 93 and the position signal 96. While the output signal 142 is only based on one of the force and position signals 93, 96, a switch 144 (e.g., a toggle switch) allows a user to determine which of the force and position signals 93, 96 is used.

When the switch 144 is in a first position, the force signal 93 is used by the controller 140 to generate the output signal 142. In one embodiment, the output signal 142 actuates the dump valve 142 to the second position PD2 so that fluid is communicated from the fluid pump 122 to the fluid reservoir 128 when the force signal 93 is greater than a predetermined value, which is based on the size of the sucker rod assembly 12.

When the switch 144 is in a second position, the position signal 96 is used by the controller 140 to generate the output signal 142. In one embodiment, the output signal 142 actuates the dump valve 142 to the second position PD2 so that fluid is communicated from the fluid pump 122 to the fluid reservoir 128 when the position signal 96 is within a predetermined range of values.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A tong assembly system comprising:
a case assembly defining an interior;
a tong head assembly disposed in the interior, the tong head assembly including an outer ring gear and a tong head engaged to the outer ring gear, wherein the tong head is adapted to engage a first sucker rod;
a transmission assembly joined to the case assembly, the transmission assembly being engaged to a hydraulic motor and including a backup tong assembly, the backup tong assembly including:
a backup tong having a first end and an oppositely disposed second end, the first end being adapted to hold a second sucker rod;
a load pin engaged to the second end of the backup tong and an outer casing of the transmission assembly, the load pin including a plurality of strain gages for measuring a force applied to the first end of the backup tong, the load pin being adapted to output a force signal; and
a rotary encoder engaged to a shaft of the hydraulic motor, the rotary encoder being adapted to output a position signal.

2. A tong assembly system according to claim 1, further comprising a controller generating an output signal based on only one of the force signal or the position signal.

3. A tong assembly system according to claim 1, further comprising a switch for selecting the force signal or the position signal for basing the output signal.

4. A tong assembly system according to claim 1, further comprising a hydraulic fluid reservoir in fluid communication with the hydraulic motor and a valve directing hydraulic fluid from the hydraulic fluid reservoir to the hydraulic motor in the first position; the valve directing hydraulic fluid from the hydraulic motor to the hydraulic fluid reservoir in the second position.

5. A tong assembly system according to claim 2, wherein the output signal is generated when the force signal is greater than a predetermined value.

6. A tong assembly system according to claim 2, wherein the output signal is generated when the position signal is within a predetermined range of values.

7. A tong assembly system according to claim 2, wherein the output signal actuates the valve to the second position.

8. A tong assembly system comprising:
a case assembly defining an interior;
a tong head assembly disposed in the interior, the tong head assembly including an outer ring gear and a tong head engaged to the outer ring gear, wherein the tong head is adapted to engage a first sucker rod;
a transmission assembly engaged to the case assembly, the transmission assembly being engaged to a hydraulic motor and including a backup tong assembly, the backup tong assembly including:
a backup tong having a first end and an oppositely disposed second end, the first end being adapted to hold a second sucker rod;
a load pin engaged to the second end of the backup tong and an outer casing of the transmission assembly, the load pin including a plurality of strain gages for measuring a force applied to the first end of the backup tong, the load pin being adapted to output a force signal; and
a rotary encoder engaged to a shaft of the hydraulic motor, the rotary encoder being adapted to output a position signal;
a hydraulic fluid reservoir in fluid communication with the hydraulic motor;
a valve directing hydraulic fluid from the hydraulic fluid reservoir to the hydraulic motor in the first position; the valve directing hydraulic fluid from the hydraulic motor to the hydraulic fluid reservoir in the second position;
a controller generating an output signal for actuating the valve to the second position selectively based on only one of the force signal or the position signal, the output signal being generated when the force signal is greater than a predetermined value or when the position signal is within a predetermined range of values.

9. A method of tightening a first tubular to a second tubular with a tong assembly including:
tong assembly system comprising:
a case assembly defining an interior;
a tong head assembly disposed in the interior, the tong head assembly including an outer ring gear and a tong head engaged to the outer ring gear, wherein the tong head is adapted to engage a first sucker rod;
a transmission assembly joined to the case assembly, the transmission assembly being engaged to a hydraulic motor and including a backup tong assembly, the backup tong assembly including:
a backup tong having a first end and an oppositely disposed second end, the first end being adapted to hold a second sucker rod;
a load pin engaged to the second end of the backup tong and an outer casing of the transmission assembly, the load pin including a plurality of strain gages for measuring a force applied to the first end of the backup tong, the load pin being adapted to output a force signal; and
a rotary encoder engaged to a shaft of the hydraulic motor, the rotary encoder being adapted to output a position signal;
a hydraulic fluid reservoir in fluid communication with the hydraulic motor;
a valve directing hydraulic fluid from the hydraulic fluid reservoir to the hydraulic motor in the first position; the valve directing hydraulic fluid from the hydraulic motor to the hydraulic fluid reservoir in the second position;
a controller generating an output signal for actuating the valve to the second position based on only one of the force signal or the position signal,
the method comprising:
selecting only one of either force or position to determine tightness;
threading the first tubular to the second tubular;
wherein if force is selected, the controller generates the output signal from the controller when the force signal is greater than a predetermined value; or wherein if position is selected, the controller generates the output signal when the position signal is within a predetermined range of values.
